(19) United States
(12) Patent Application Publication
(10) Pub. No.: US 2022/0063897 A1
(43) Pub. Date: Mar. 3, 2022

(54) EGG STORAGE PLATE

(71) Applicant: Denk Keramische Werkstätten e. K., Coburg (DE)

(72) Inventors: Fabian Denk, Coburg (DE); Luca Galmarini, Castellamonte (IT)

(21) Appl. No.: 17/403,935

(22) Filed: Aug. 17, 2021

(30) Foreign Application Priority Data
Sep. 1, 2020 (DE) 10 2020 122 789.2

(51) Int. Cl. B65D 85/32; A23B 5/00

(52) U.S. Cl. CPC B65D 85/32; A23B 5/00

(57) ABSTRACT

The invention relates to an egg storage plate having a base surface, an egg contact surface and at least one outer peripheral surface. The egg contact surface has a track which extends from a high point to a low point, wherein in the direction of the surface normal of the base surface the high point is spaced furthest from the base surface and the low point is spaced least from the base surface. The track runs between the high point and the low point with a continuous gradient. The track has a curvature such that the centerline of the track, in projection onto the base surface, is not radially offset at the high point or is offset by no more than one-half of a track width relative to the low point. The track is substantially convex in cross-section and the track width corresponds to between 80% and 120% of the longitudinal extent of an average egg to be stored.

### BACKGROUND OF THE INVENTION

The invention relates to an egg storage plate having a base surface, an egg contact surface and at least one outer peripheral surface extending between the base surface and the egg contact surface. The egg storage plate is particularly suitable for the natural storage of hen's eggs, protected from bacteria and preferably also without cooling.

Chicken eggs are usually delivered in protective packs containing 6, 10 or 12 eggs in an upright position from the producer to the retailer, where they are dispensed to the consumer. Likewise, stackable egg pallets are known, with which larger quantities are delivered to the catering trade or similar customers with higher consumption. The eggs are also arranged in standing position in the pallets.

Chicken eggs, for example, are usually stored in households and in the catering industry for several days after purchase before reaching their point of consumption. Nowadays, eggs are mostly stored in refrigerators or cold rooms, as it is widely believed that refrigerated eggs would have a longer shelf life and that possible health damage caused by pathogens, especially salmonella, could be better avoided through refrigeration.

Due to its ovoid shape, the natural position of an egg, is however in a horizontal/lying position, just as the egg would lie in the nest of a chicken in natural conditions. In this lying position, the yolk is held in the center of the egg by the chalazae, in such a manner that it has no contact with the air chamber in the egg. If the egg is now transported and stored upright, as is usually the case in practice, the chalazae slacken due to the non-natural position and the yolk can come into contact with the air chamber. Bacteria can then develop in the egg. The same can happen through contact with the permeable shell skin. Storing an egg in a standing position can thus lead to bacterial growth and faster spoilage of the egg. To counteract this, most consumers keep the egg refrigerated after purchase.

DE 10 2016 006 219 A1 shows an example of an egg tray with openings for holding a plurality of eggs, preferably for use as a storage area in a refrigerator. This egg tray has an upper side and a lower side, wherein openings on the upper side are partially larger or smaller than on the lower side. The egg tray is used for space-saving, upright storage of eggs of different sizes.

When eggs are stored in the refrigerator, they can take on the odors of other foodstuffs stored there. There is also the problem that eggs, which are usually stored in the egg tray on the inside of the refrigerator door, are exposed to frequent temperature changes when the door is opened, which can damage the protective membrane (shell skin) of the egg. Damage to this membrane can lead to undesirable bacterial growth. Another disadvantage is that, for example, in the production of baked goods, the eggs used are to be processed at room temperature. This requires the early stage removal of the eggs from the refrigerator. Lastly, the energy required for cooling the eggs has a negative impact on the overall energy budget of the household.

One task of the invention is to provide an egg storage plate that allows storage of multiple eggs while avoiding the above disadvantages. In particular, the eggs are to be stored for several days in such a way that contamination by bacteria is largely excluded without the need for cooling the eggs. Preferably, it should also be possible to tell from the position of the eggs, without further marking, which of the eggs has been stored the longest and should therefore be consumed first.

This task is solved by an egg storage plate according to the appended claim 1.

### SUMMARY OF THE INVENTION

The invention is firstly based on the realization that refrigerated storage of the eggs is not necessary under improved storage conditions, this without resulting in poorer shelf life or increased health risks. If the egg is left in its natural horizontal/lying position, including during storage at the consumer, this already significantly prevents the formation of germs in the egg. This is because the egg white has naturally bactericidal properties, whereas the yolk does not have such safety mechanisms. A further improvement can be achieved if the chalazae are not subjected over a long period of time to gravitational loading in one direction only, but rather are submitted to compensating conditions brought about by occasional rotation of the egg about its longitudinal axis. The chalazae thus remain taut and flexible. The yolk is then prevented from coming into contact with the air chamber and with the permeable shell skin, which prevents the development of bacteria in the yolk.

In order to implement these findings in a technical solution to the above-mentioned problem, the egg storage plate according to the invention has a base surface which can be designed as a closed or open surface and allows the egg storage plate to be placed, for example, on a work surface or the like. Furthermore, the egg storage plate has an egg contact surface which is substantially opposite the base surface, but which has partially differentiated spacing therefrom. The egg storage plate has a track which extends from a high point to a low point, wherein in the direction of the surface normal of the base surface the high point is spaced furthest from the base surface and the low point is spaced least from the base surface. The track runs between the high point and the low point without points of discontinuity and without reversal points, preferably with a constant negative gradient or alternatively slope from the high point to the low point. The gradient is selected so that the placed eggs roll automatically from the high point to the low point. The track also has a curvature such that the centerline of the track, in projection onto the base surface, is not radially offset at the high point or is offset by no more than one-half of a track width relative to the low point. Preferably, the projection of the centerline of the track therefore substantially describes a circular path section, particularly preferably over an angular range of more than 275°. Seen in a transverse cross-section, the track is substantially convex in shape and has a track width which is adapted to the longitudinal extent of an egg to be stored, in particular corresponding to between approximately 80% and 120% of the longitudinal extent of an average chicken egg. Finally, at least one outer peripheral surface is provided which extends between the base surface and the egg contact surface and thus delimits the body of the egg storage plate on the outer peripheral surface.

The design of the egg storage plate ensures that the eggs placed on the track of the egg contact surface are permanently in the horizontal/lying position, because the track width is selected in such a way that each egg placed on it cannot remain in the upright position but rather necessarily transfers to the horizontal/lying position by the force of gravity, wherein the convex cross-sectional shape results in at least linear or alternatively flat contact of the egg with the track surface. In addition, the gradient of the track causes all the eggs placed on it to automatically pursue the direction of the low point. The track provides a stable path for the eggs to safely roll around their longitudinal axis. As soon as an egg is removed from the low point, the other eggs roll along the track and are rotated by several degrees in the desired manner, thus relieving the chalazae.

According to a preferred embodiment, the track is delimited at its outer edge by the outer peripheral surface and at its inner edge by an inner peripheral surface. The two peripheral surfaces extend between the base surface and the egg storage plate, giving the egg storage plate a three-dimensional shape that preferably has no sharp edges or corners. Particularly preferably, the inner peripheral surface encloses a central recess. Furthermore, it is advantageous if the inner and outer peripheral surfaces are inclined towards each other so as to enclose a portion of a truncated cone. The track then describes a helical line which runs in a sectional plane of the truncated cone inclined to the axis of rotation. The central recess results in a material and weight saving and at the same time allows comfortable gripping of the egg storage plate by the user.

In an advantageous embodiment, the entire egg storage plate is formed in one piece from a ceramic material. The sintered ceramic is densely fired, chemically inert, does not absorb bacteria or odors, and can be cleaned with a soap solution as well as with weak acids and alkalis for special requirements. By manufacturing using molding or casting techniques, the material thickness can be kept relatively thin and thus the egg storage plate can be kept light overall.

Particularly preferably, the egg storage plate is made of unglazed ceramic with titanium dioxide admixed during the manufacturing process. This creates a bactericidal surface. The material treated in this way is chemically inert and suitable for foodstuffs. Anatase and rutile pigments are formed as variations of titanium dioxide on the surface of the ceramic body during firing above 800° C. These pigments are photocatalytic and can be used to remove bacteria. These pigments are photocatalytically active. When exposed to light in combination with atmospheric oxygen and humidity, free reactive hydroxyl and peroxyl radicals are formed. These free radicals react with local organic compounds (such as bacteria) and destroy them. Preferably, approx. 2% titanium dioxide is admixed to the ceramic raw material, resulting in a functional, microscopically visible surface effect due to rutile and anatase pigments. The pigments are bound in the ceramic and cannot be detached or alternatively flushed out. As a result, the ceramic used has a bactericidal effect and thus increases the maximum storage time of the eggs on the egg storage plate. In use, the egg storage plate is preferably placed outside a refrigerator, which on the one hand avoids cooling and on the other hand ensures exposure to light in order to keep the aforementioned photocatalysis process going.

In a further embodiment, an upper run surface adjoins the high point of the track, and a lower run surface adjoins the low point. The upper run surface primarily prevents the egg from accidentally dropping when it is placed on the upper end of the track. The lower run surface prevents the eggs that are placed thereupon from leaving the track on their own. Particularly preferably, the two run surfaces are formed as opposite sides of an elevation placed between the high point and the low point.

According to an advantageous embodiment, the inner edge of the substantially convex-shaped track is spaced, along its entire length, further away from the base surface than from the outer edge lying parallel opposite it. In other words, the elevation of the inner edge relative to the base surface is preferably slightly greater along its entire course than the elevation of the outer edge, relative to a radial line which intersects both edges. The convex shape of the track thus mimics the ovoid shape of the eggs. This means that the eggs to be placed can each be placed with their narrow end towards the inner edge and the wide end towards the outer edge and be supported in this position. The space required by the eggs on the circular track is thus minimized.

A preferred embodiment has a base surface defined by an inner position line above which the inner peripheral surface rises and an outer position line above which the outer peripheral surface rises. The base surface is moreover inwardly open, so that preferably a cavity is formed between the inner side of the egg contact surface and the peripheral surfaces. This hollow formation serves primarily to save material and reduce weight.

### BRIEF DESCRIPTION OF THE DRAWINGS

Further advantages, details and further developments of the invention will become apparent from the following description of a preferred embodiment, with reference to the drawing. Wherein:

FIG. 1 shows a top view of an egg storage plate with an egg placed on a track;

FIG. 2 shows a side view of the egg storage plate according to FIG. 1, but without the egg on top.

### DETAILED DESCRIPTION OF THE INVENTION

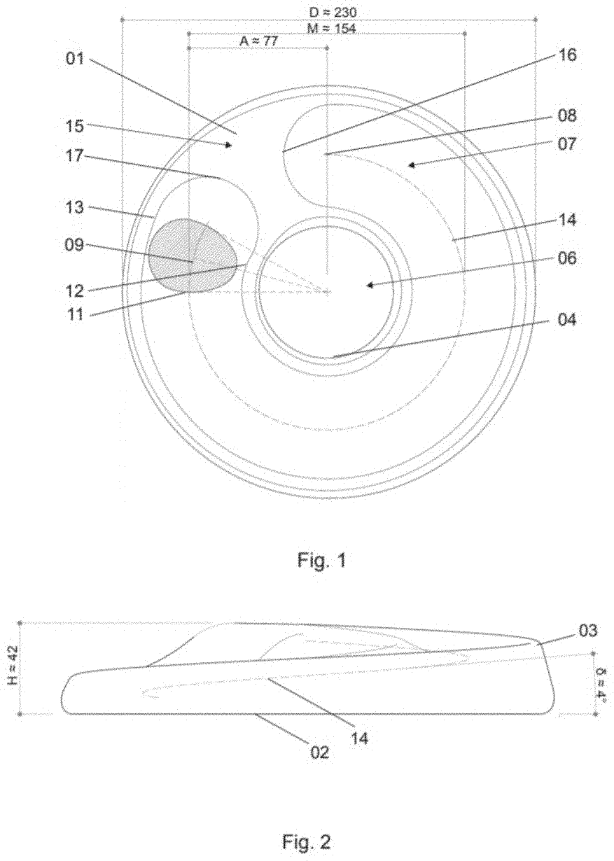

FIG. 1 shows a preferred embodiment of an egg storage plate in a top view, whereas FIG. 2 shows a side view. This embodiment is described below with concurrent reference to both figures. The dimension lines and values (in millimeters and degrees, respectively) shown in the figures are only intended to illustrate preferred dimensions and are not to be understood as necessary features. Deviations in the dimensions are possible as long as the functionality is still fulfilled. In particular, a dimensional adjustment is required if the egg storage plate is not to be configured for chicken eggs but, for example, rather for quail eggs.

In use, the egg storage plate has an egg contact surface 01 located on the top-facing side, a base surface 02 located opposite the egg contact surface 01, and an outer peripheral surface 03 and an inner peripheral surface 04, each of which extending between the egg contact surface 01 and the base surface 02. The base surface 02 is preferably not closed but is formed only in the region of the peripheral surfaces. The peripheral surfaces 03, 04 are inclined in opposite directions, for example at an angle of 80° or 100° to the base surface. The basic shape of the egg storage plate corresponds to a truncated cone with an inner recess 06. In a dimensional adaptation of the egg storage plate, for example, for storage of hen's eggs, the outer diameter is D≈230 mm and the height is H≈42 mm.

The egg contact surface 01 is predominantly occupied by a track 07 which runs along a helical line from a high point 08 to a low point 09. For clarification, a single egg 11 is shown in FIG. 1 with its longitudinal axis substantially intersecting the low point 09. It can be seen that the narrow end of the egg 11 is directed towards the inside, towards an inner edge 12 of the track 07, whereas the wide end of the egg is directed towards the outside, towards an outer edge 13 of the track. The track 07 has a convex cross-section, with a centerline 14 extending in the gorge of the track 07. The inner edge 12 and the outer edge 13 run parallel to the centerline 14. The centerline 14 runs, for example, with a continuous gradient of δ≈4°. The centerline 14 describes a circular path, for example, with a diameter M≈154 mm, so that there is a radius R≈77 mm between the center of the recess 06 and the centerline 14.

When viewed along a radius line, the inner edge 12 is formed slightly higher than the outer edge 13, which is to say that the inner edge is always spaced slightly further away from the base surface 02 than from the outer edge. As a result, the narrow end of the placed egg 11 is raised so that the longitudinal axis of the egg 11 is approximately horizontal, regardless of the position of the egg 11 on the track 07.

There is an elevation 15 between the high point 08 and the low point 09, which elevation compensates for the difference in height between these points. The elevation 15 has two side surfaces facing the track, forming an upper run surface 16 and a lower run surface 17.

In the design shown, the entire egg storage plate is formed in one piece from sintered ceramic. Titanium dioxide was admixed to the ceramic raw material during the manufacturing process.

When an egg 11 is placed on the egg storage plate at the high point 08, the gradient of the track 07 causes it to automatically roll to the low point 09 or to a point at which the egg abuts a previously placed egg. In total, depending on the size of the eggs, about 10-12 hen's eggs can be placed on the track 07 with the dimensions mentioned as an example.

1. Egg storage plate having a base surface (02), an egg contact surface (01) and at least one outer peripheral surface (03) extending between the base surface (02) and the egg contact surface (01), characterized in that:
the egg contact surface (01) has a track (07) which extends from a high point (08) to a low point (09), the high point (08) being spaced farthest and the low point (09) being spaced least from the base surface (02) in the direction of the surface normal of the base surface (02);
the track (07) runs between the high point (08) and the low point (09) with a gradient without points of discontinuity and without reversal points;
the track (07) has a curvature such that the centerline (14) of the track (07) in projection onto the base surface (02) is not radially offset at the high point (08) or is offset by no more than half of a track width relative to the low point (09);
the track (07) is substantially convex in cross-section and the track width corresponds to between 80% and 120% of the longitudinal extent of an average egg (11) to be stored.

2. Egg storage plate according to claim 1, wherein the track (07) is delimited at its outer edge (13) by the outer peripheral surface and is delimited at its inner edge (12) by an inner peripheral surface extending between the base surface (02) and the egg contact surface (01).

3. Egg storage plate according to claim 2, wherein the inner peripheral surface (03) encloses a central recess (06).

4. Egg storage plate according to claim 3, wherein the inner and outer peripheral surfaces (03, 04) are inclined towards each other so as to enclose a portion of a truncated cone.

5. Egg storage plate according to claim 1, wherein it is formed in one piece out of a ceramic material, in particular of an unglazed ceramic, with titanium dioxide admixed to the ceramic raw material.

6. Egg storage plate according to claim 1, wherein an upper run surface (16) is formed in the vicinity of the high point (08) and a lower run surface (17) is formed in the vicinity of the low point (09), which prevent the eggs (11) that are placed thereupon from leaving the track (07) on their own.

7. Egg storage plate according to claim 1, wherein the gradient between the high point (08) and low point (09) is continuous.

8. Egg storage plate according to claim 1, wherein the track (07) runs along a helical line with a constant negative pitch between the high point (08) and the low point (09).

9. Egg storage plate according to claim 1, wherein the middle line (14) of the track (07) in projection onto the base surface (02) runs in a circular shape.

10. Egg storage plate according to claim 1, wherein the inner edge (12) of the substantially convex-shaped track (07) is always spaced, along its entire length, further away from the base surface (02) than from the outer edge (13) lying parallel opposite it.

11. Egg storage plate according to claim 1, wherein base surface (02) is defined by an inner position line, above which the inner peripheral surface (04) rises, and by an outer positional line, above which the outer peripheral surface (03) rises.

12. Egg storage plate according to claim 1, wherein a cavity that is open towards the base surface (02) is formed between the inner side of the egg contact surface (01) and the peripheral surfaces (03, 04).
